(19) United States
(12) Patent Application Publication
(10) Pub. No.: US 2009/0299738 A1
(43) Pub. Date: Dec. 3, 2009

(54) VECTOR QUANTIZING DEVICE, VECTOR DEQUANTIZING DEVICE, VECTOR QUANTIZING METHOD, AND VECTOR DEQUANTIZING METHOD

(75) Inventors: Kaoru Sato, Osaka (JP); Toshiyuki Morii, Osaka (JP); Tomofumi Yamanashi, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/295,342

(22) PCT Filed: Mar. 29, 2007
(86) PCT No.: PCT/JP2007/056951

§ 371 Date: Sep. 30, 2008

(30) Foreign Application Priority Data
Mar. 31, 2006 (JP) 2006-099854

(51) Int. Cl. G10L 21/00

(52) U.S. Cl. 704/222; 704/E21.001

(57) ABSTRACT

A vector quantizing device for dividing a sequence of vectors and quantizing them with an enhanced performance of vector quantization by using information on the correlation between the high and low order that the vector sequence has. The vector quantizing device (100) creates a predicted vector by prediction using a first quantization divided vector, creates the difference between the divided vector and the predicted vector as a predicted residual vector, and determines a second code by converting the predicted residual vector into a quantized vector. A vector dequantizing device (150) creates a predated vector by prediction using a first quantization divided vector, creates a second quantization divided vector by adding the predicted vector and the predicted residual vector, and creates a quantized vector by connecting the first and second quantization divided vectors.

### TECHNICAL FIELD

The present invention relates to a vector quantization apparatus, vector dequantization apparatus, vector quantization method and vector dequantization method for quantizing a plurality of vectors (split vectors) acquired by splitting an input vector to be quantized.

### BACKGROUND ART

In the field of digital wireless communication, packet communication represented by Internet communication and speech storage, speech signal coding/decoding techniques are essential for effective use of the channel capacity of radio waves and storage media, and many speech coding/decoding schemes have so far been developed. Among these, a CELP speech coding/decoding scheme is practically used as a mainstream scheme (for example, see Non-Patent Document 1).

A speech coding apparatus of the CELP scheme encodes input speech based on pre-stored speech models. To be more specific, the speech coding apparatus separates a digital speech signal into frames of approximately 10 to 20 ms, performs a linear prediction analysis of the speech signal on a per frame basis, finds the linear prediction coefficients (“LPC's”) and a linear prediction residual vector, and encodes the linear prediction coefficients and the linear prediction residual vector individually.

As a method of encoding linear prediction coefficients, a speech coding apparatus of the CELP scheme generally employs the method of converting the linear prediction coefficients into line spectral pairs (“LSPs”) and encoding the line spectral pairs. Further, as a method of encoding LSPs, vector quantization is likely to be used. Further, when the amount of calculation is large upon vector-quantizing a vector directly, split vector quantization (“split VQ”) is likely to be used, whereby a plurality of split vector sequences acquired by splitting a vector sequence are quantized.

Patent Document 1: Japanese Patent Application Laid-Open No. Hei 10-97295
Non-Patent Document 1: M. R. Schroeder, B. S. Atal, “Code Excited Linear Prediction High Quality Speech at Low Bit Rate,” IEEE proc., ICASSP'85 pp. 937-940

### DISCLOSURE OF INVENTION

### Problem to be Solved by the Invention

However, in a conventional vector quantization apparatus, although the amount of calculation for comparison is reduced by split vector quantization, information about the correlation prior to split, is lost, resulting in deterioration of the performance of split vector quantization. For example, when split vector sequences acquired by splitting a vector sequence are quantized in the same way as split vector quantization, information about correlation is lost by splitting a vector sequence like the LSP having correlation between the higher order (meaning the high frequency domain) and the lower order (meaning the low frequency domain) of a vector, resulting in deterioration of the performance of quantization.

It is therefore an object of the present invention to provide a vector quantization apparatus, vector dequantization apparatus, vector quantization method and vector dequantization method for improving vector quantization performance when a vector sequence is split and quantized.

### Means for Solving the Problem

The vector quantization apparatus of the present invention employs a configuration having: a split section that splits an input vector and acquires a plurality of split vectors; a first quantizing section that quantizes one of the split vectors and acquires a first quantized split vector and a first code representing the first quantized split vector; a second quantizing section that quantizes another split vector using a quantization result in the first quantizing section and acquires a second code; and a multiplexing section that multiplexes the first code and the second code and acquires a vector code.

The vector dequantization apparatus of the present invention employs a configuration having: a demultiplexing section that demultiplexes the vector code outputted from the above vector quantization apparatus into a first code and a second code; a first dequantizing section that dequantizes the first code and acquires a first quantized split vector; a second dequantizing section that acquires a second quantized split vector by dequantizing the second code using a dequantization result in the first dequantizing section; and a coupling section that couples the first quantized split vector and the second quantized split vector and generates a quantized vector.

The vector quantization method of the present invention employs a method including: a split step of splitting an input vector into a plurality and acquiring a plurality of split vectors; a first quantization step of quantizing one of the split vectors and a first code representing the first quantized split vector and acquiring a first quantized split vector; a second quantization step of quantizing another split vector using a quantization result in the first quantizing step and acquiring a second code; and a multiplexing step of multiplexing the first code and the second code and acquiring a vector code.

The vector dequantization method of the present invention employs a method including: a demultiplexing step of demultiplexing the vector code outputted by the above vector quantization method into a first code and a second code; a first dequantization step of dequantizing the first code and acquiring a first quantized split vector; a second dequantization step of acquiring a second quantized split vector by dequantizing the second code using a dequantization result in the first dequantizing step; and a coupling step of coupling the first quantized split vector and the second quantized split vector and generating a quantized vector.

### ADVANTAGEOUS EFFECT OF THE INVENTION

According to the present invention, the correlation between the higher order and the lower order of a vector sequence can be used, so that it is possible to improve the performance of vector quantization.

### BRIEF DESCRIPTION OF DRAWINGS

FIG. 1 is a block diagram showing a configuration of a vector quantization apparatus and vector dequantization apparatus according to Embodiment 1 of the present invention;

FIG. 2 is a block diagram showing a configuration of a vector quantization apparatus and vector dequantization apparatus according to Embodiment 2 of the present invention; and

FIG. 3 illustrates an association table between indexes of a second codebook and first codes of a vector quantization apparatus and vector dequantization apparatus according to Embodiment 2 of the present invention.

### BEST MODE FOR SOLVING THE PROBLEM

Embodiments of the present invention will be explained below in detail with reference to the accompanying drawings. Further, example cases will be explained with embodiments where split vector quantization of LSP's is performed in speech and sound coding/decoding. Further, example cases will be explained with the embodiments where the number of splits of an input vector is two and the quantization target or quantization method for one split vector is changed depending on the quantization result of the other split vector.

### Embodiment 1

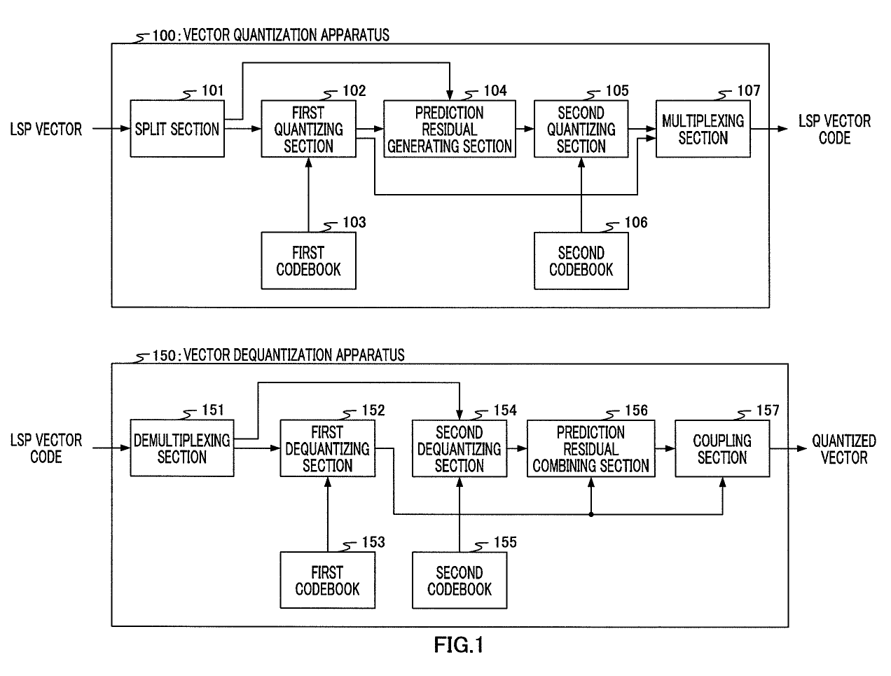

FIG. 1 is a block diagram showing main components of the vector quantization apparatus and vector dequantization apparatus according to Embodiment 1 of the present invention.

In FIG. 1, vector quantization apparatus 100 is mainly configured with split section 101, first quantizing section 102, first codebook 103, prediction residual generating section 104, second quantizing section 105, second codebook 106 and multiplexing section 107. Further, vector dequantization apparatus 150 is mainly configured with demultiplexing section 151, first dequantizing section 152, first codebook 153, second dequantizing section 154, second codebook 155, prediction residual combining section 156 and coupling section 157.

Split section 101 splits an input vector into two and acquires two split vectors. Here, assume that, out of the two split vectors, the split vector of the lower order (meaning the low frequency area) is referred to as the “first split vector” and the split vector of the higher order (meaning the high frequency area) is referred to as the “second split vector.”

First quantizing section 102 acquires the first quantized split vector by quantizing the first split vector using first codebook 103 and acquires the first code representing the first quantized split vector. Prediction residual generating section 104 generates a predicted vector by performing a prediction using the first quantized split vector and generates a prediction residual vector representing the prediction error between the predicted vector and the second split vector. Second quantizing section 105 acquires a second code by quantizing the prediction residual vector using second codebook 106. Multiplexing section 107 multiplexes the first code quantized in first quantizing section 102 and the second code quantized in second quantizing section 105, and outputs the resulting LSP vector code.

Further, demultiplexing section 151 demultiplexes the LSP vector code multiplexed in vector quantization apparatus 100 into the first code and the second code. First dequantizing section 152 acquires a first quantized split vector by dequantizing the first code using first codebook 153. Second dequantizing section 154 acquires a quantized prediction residual vector by dequantizing the second code using second codebook 155. Prediction residual combining section 156 generates a predicted vector by performing a prediction using the first quantized split vector and generates the second quantized split vector by combining the predicted vector and the quantized prediction residual vector. Coupling section 157 couples the first quantized split vector and the second quantized split vector and generates a quantized vector.

The operations of the vector quantization apparatus and vector dequantization apparatus employing the above configurations will be explained below.

First, the operations of the sections of vector quantization apparatus 100 will be explained.

In this case, split section 101 receives as input an input vector that is an LSP vector. Split section 101 splits the inputted LSP vector into two, and outputs the first split vector and the second split vector generated by the splitting, to first quantizing section 102 and prediction residual generating section 104, respectively.

First quantizing section 102 quantizes the first split vector and outputs the first quantized split vector and the first code representing the first quantized split vector, which are acquired by quantization, to prediction residual generating section 104 and multiplexing section 107, respectively. Upon performing vector quantization, first quantizing section 102 refers to first codebook 103.

Prediction residual generating section 104 receives as input the first quantized split vector and the second split vector, performs a prediction using the first quantized split vector, generates a predicted vector based on the prediction result and finds the difference between the second split vector and the predicted vector, thereby finding a prediction residual vector and outputting the prediction residual vector to second quantizing section 105. Thus, in prediction residual generating section 104, by predicting the second split vector from the quantization result in first quantizing section 102 and targeting the prediction residual for vector quantization, it is possible to improve the performance of split vector quantization using the correlation between the first split vector and the second split vector.

Second quantizing section 105 receives as input the prediction residual vector, quantizes the prediction residual vector and outputs a second code acquired by the quantization to multiplexing section 107. Upon performing vector quantization, second quantizing section refers to second codebook 106.

Multiplexing section 107 receives as input the first code and the second code, multiplexes these codes and outputs the result as an LSP vector code.

Next, the operations of the sections of vector dequantization apparatus 150 will be explained.

Demultiplexing section 151 receives as input the LSP vector code. Demultiplexing section 151 demultiplexes the LSP vector code into the first code and the second code, and outputs the first code to first dequantizing section 152 and the second code to second dequantizing section 154.

First dequantizing section 152 receives as input the first code, dequantizes the first code and outputs the first quantized split vector acquired by the dequantization to prediction residual combining section 156 and coupling section 157. Here, upon performing vector dequantization, first dequantizing section 152 refers to first codebook 153.

Second dequantizing section 154 receives as input the second code, dequantizes the second code and outputs the quantization prediction residual vector acquired by the dequantization to prediction residual combining section 156. Here, upon performing dequantization, second dequantizing section 154 refers to second codebook 155.

Prediction residual combining section 156 receives as input the first quantized split vector and the quantization prediction residual vector, performs a prediction using the first quantized split vector, generates a predicted vector based on the prediction result and calculates the sum of the predicted vector and the quantization prediction residual vector, thereby finding a second quantized split vector and outputting the second quantized split vector to coupling section 157.

Coupling section 157 receives as input the first quantized split vector and the second quantized split vector, finds a quantized vector by combining the first quantized split vector and the second quantized split vector and outputs the quantized vector.

Next, the operations of the sections of vector quantization apparatus 100 and dequantization apparatus 150 will be explained in further detail.

First, the operations of the sections of vector quantization apparatus 100 will be explained.

An example case will be explained where an LSP vector to be quantized is a vector of the R order (LSP(i) (i=0 to R−1)), and where vector quantization apparatus 100 splits the vector of the R order into two, namely, a split vector of the R_P order and a split vector of the R_F order and performs split vector quantization.

Split section 101 splits an input LSP vector (LSP(i) (i=0 to R−1)) according to following equation 1. In the LSP vector (LSP(i) (i=0 to R−1)), the value of a frequency increases in order from the LSP(0), which is the lowest frequency to the LSP(R−1), which is the highest frequency.

[1]

LSP_{—}P(i)=LSP(i) (i=0, . . . , R_P−1)

LSP_{—}F(i)=LSP(i+R_{—}P) (i=0, . . . , R_F−1) (Equation 1)

In above equation 1, assume that the first split vector is the LSP_P(i) (i=0 to R_P−1) and the second split vector is the LSP_F(i) (i=0 to R_F−1). Further, the sum of R_P and R_F corresponds to R (R=R_P+R_F).

First quantizing section 102 receives as input the first split vector LSP_P(i) (i=0 to R_P), and, with reference to first codebook 103 prepared in advance by learning, selects the code vector that minimizes the square error between the code vector and the first split vector LSP_P(i) (i=0 to R_P) using following equation 2.

$$\begin{matrix}( Equation 2 ) & \\ Err\_P = {\sum }_{i = 0}^{R\_P - 1} {( LSP\_P ( i ) - {CODE\_P}^{( m )} ( i ) )}^{2} & [ 2 ]\end{matrix}$$

In above equation 2, (i) (i=0 to R_P−1) is the code vectors forming first codebook 103 and m is the indexes of the code vectors. When the codebook size of first codebook 103 is M, m take values between 0 and M−1. First quantizing section 102 calculates values of the square error Err_P using above equation 2 and all m's, and outputs the m that minimizes the value of the square error Err_P as the first code m_min to multiplexing section 107. Further, first quantizing section 102 outputs the code vector CODE_P^{(m}^{_{—}}^{min)}(i) (i=0 to R_P−1) that minimizes the square error Err_P to prediction residual generating section 104 as the first quantized split vector.

Next, prediction residual generating section 104 receives as input the first quantized split vector CODE_P^{(m}^{_{—}}^{min)}(i) (i=0 to R_P−1) and the second split vector LSP_F(i) (i=0 to R_P−1), and performs a prediction using the first quantized split vector CODE_P^{(m}^{_{—}}^{min)}(i). Here, an example case will be explained where a prediction is performed using the value of the CODE_P^{(m}^{_{—}}^{min)} (R_P−1), which is one element of the first quantized split vector. The prediction is performed using following equation 3.

$$\begin{matrix}( Equation 3 ) & \\ PRED ( i ) = \frac{Z - {CODE\_P}^{( m\_min )} ( R\_P - 1 )}{R\_F + 1} \times ( i + 1 ) + {CODE\_P}^{( m\_min )} ( R\_P - 1 ) \\ ( i = 0 , … , R\_F - 1 ) & [ 3 ]\end{matrix}$$

Here, the value of Z is the maximum value that can be taken in the LSP vector (LSP(i) (i=0 to L−1)) using an arbitrary i, and is determined from a large number of LSP vectors that are experimentally found using a large volume of speech data. The PRED(i) (i=0 to R_F−1) calculated in above equation 3 is the predicted vector that was predicted. Next, a prediction residual vector is found using following equation 4.

PRED_ERR(i)=LSP_{—}F(i)−PRED(i) (i=0, . . . , R_F−1) (Equation 4)

Next, prediction residual generating section 104 outputs the prediction residual vector PRED_ERR(i) (i=0 to R_F−1) found in above equation 4, to second quantizing section 105.

Next, second quantizing section 105 receives as the input prediction residual vector PRED_ERR(i) (i=0 to R_F−1), and, with reference to second codebook created in advance by learning, selects the code vector that minimizes the square error between the code vector and the prediction residual vector PRED_ERR(i) (i=0 to R_F−1) using following equation 5.

$$\begin{matrix}( Equation 5 ) & \\ Err\_F = {\sum }_{i = 0}^{R\_F - 1} {( PRED\_ERR ( i ) - {CODE\_F}^{( n )} ( i ) )}^{2} & \end{matrix}$$

However, the CODE_F⁽ⁿ⁾ (i) (i=0 to R_F−1) is the code vectors forming second codebook 106 and n is the indexes of the code vectors. If the codebook size of second codebook 106 is N, n take values between 0 and N−1. Second quantizing section 105 calculates the values of the square error Err_F in all n's using above equation 5 and outputs the n that minimizes the value of the square error Err_F as the second code n_min to multiplexing section 107.

Next, multiplexing section 107 receives as input the first code m_min and the second code n_min and multiplexes these codes into an LSP vector.

As described above, by predicting a second split vector from the first quantized split vector acquired by the quantization result in first quantizing section 102 (or from CODE_P^{(m}^{_{—}}^{min)}(R_P−1) that is one element of the first quantized split vector) and targeting the prediction error for quantization in second quantizing section 105, it is possible to improve the performance of split vector quantization using the correlation between the first split vector and the second split vector.

Next, the operations of the sections of vector dequantization apparatus 150 will be explained in detail.

An example case will be explained where an LSP vector to be quantized is a vector of the R order (LSP(i) (i=0 to R−1)), and where vector dequantization apparatus 150 acquires a quantized vector by dequantizing an LSP vector code. Further, first codebook 153 has the same configuration as first codebook 103 in vector quantization apparatus 100 and second codebook 155 has the same configuration as second codebook 106 in vector quantization apparatus 100.

First, demultiplexing section 151 demultiplexes the LSP vector into the first code m_min and the second code n_min and outputs the first code m_min to first dequantizing section 152 and the second code n_min to second dequantizing section 154.

Next, first dequantizing section 152 acquires the first quantized split vector using the first code m_min. To be more specific, first dequantizing section 152 acquires the first quantized split vector CODE_P^{(m}^{_{—}}^{min)}(i) (i=0 to R_P−1) with reference to first codebook 153. Next, first dequantizing section 152 outputs the first quantized split vector CODE_P^{(m}^{_{—}}^{min)}(i) (i=0 to R_P−1) to prediction residual combining section 156 and coupling section 157.

Next, second dequantizing section 154 acquires the quantization prediction residual vector using the second code n_min. To be more specific, with reference to second codebook 155, second dequantizing section 154 acquires the quantized prediction residual vector CODE_F⁽ⁿ^{_{—}}^{min)}(i) (i=0 to R_F−1). Next, second dequantizing section 154 outputs the quantized prediction residual vector CODE_F⁽ⁿ^{_{—}}^{min)}(i) (i=0 to R_F−1) to prediction residual combining section 156.

Next, prediction residual combining section 156 receives as input the first quantized split vector CODE_P^{(m}^{_{—}}^{min)}(i) (i=0 to R_P−1) and the quantized prediction residual vector CODE_F⁽ⁿ^{_{—}}^{min)}(i) (i=0 to R_F−1), and finds the predicted vector PRED(i) (i=0 to R_F−1) using above equation 3. Next, prediction residual combining section 156 outputs the second quantized split vector Q_F(i) (i=0 to R_F−1) found in following equation 6, to coupling section 157.

[6]

Q_{—}F(i)=CODE_{—}F⁽ⁿ^{_{—}}^{min)}(i)+PRED(i) (i=0, . . . , R_F−1) (Equation 6)

Next, coupling section 157 receives as input the first quantized split vector CODE_P^{(m}^{_{—}}^{min)}(i) (i=0 to R_P−1) and the second quantized split vector Q_F(i) (i=0 to R_F−1), generates the quantized vector Q(i) (i=0 to R−1) by coupling these vectors using following equation 7 and outputs the quantized vector Q(i).

[7]

Q(i)=CODE_P^{(m}^{_{—}}^{min)}(i) (i=0, . . . , R_P−1)

Q(i+R_{—}P)=Q_{—}F(i) (i=0, . . . , R_F−1) (Equation 7)

As described above, according to the present embodiment, vector quantization apparatus 100 generates a predicted vector by performing a prediction using a first quantized split vector, generates a prediction residual vector using the difference between the split vector and the predicted vector, and acquires a second code by vector-quantizing the prediction residual vector. Further, vector dequantization apparatus 150 generates a predicted vector by performing a prediction using the first quantized split vector, generates a second quantized split vector by calculating the sum of the predicted vector and the prediction residual vector, and generates a quantized vector by coupling the first quantized split vector and the second quantized split vector.

As described above, according to the present embodiment, it is possible to acquire a quantized split vector by quantizing one of split vectors and change the quantization target or a quantization method in quantization of the other split vector according to the quantization result of the split vector. By this means, in split vector quantization, information about the correlation between the higher order and the lower order of a vector sequence is used when the vector sequence is split, so that it is possible to improve the performance of split vector quantization utilizing the correlation between the higher order and the lower order of the input vector.

To be more specific, even when a vector sequence with the correlation between the higher order and the lower order is subjected to split vector quantization, by predicting a second split vector using the quantization result of the first split vector and by using a prediction residual vector representing the prediction residual as a quantization target in a second quantizing section, it is possible to utilize correlation to improve the quality of quantization.

Here, to acquire first codebooks 103 and 153 in advance by learning, it is preferable to prepare a large number of LSP vectors acquired from a large volume of speech data for learning, generate a large number of first split vectors LSP_P(i) (i=0 to R_P−1) using the LSP vectors and above equation 1, and generate the first codebook by learning algorithms such as the LBG algorithm using the large number of first split vectors. Further, to acquire second codebooks 106 and 155 in advance by learning, after the first codebooks are generated using the above method, it is preferable to generate a large number of first split vectors LSP_P(i) (i=0 to R_P−1) and second split vectors LSP_F(i) (i=0 to R_F−1) based on above equation 1 using a large number of LSP vectors, select the code vector that minimizes the square error between the code vector and the first split vector LSP_P(i) (i=0 to R_P−1) using above equation 2 with reference to the first codebooks every pair of the first split vector and the second split vector, find the predicted vector PRED(i) (i=0 to R_F−1) using above equation 3, find the prediction residual vector PRED_ERR(i) (i=0 to R_F−1) using above equation 4, and generate the second codebooks by learning algorithms such as the LBG algorithm using a large number of found prediction residual vectors.

Further, although a case has been described above with the present embodiment where a predicted vector is generated by performing a prediction using one element of the first split vector, the prediction method is not limited to this and other prediction methods are equally possible. For example, it is equally possible to generate a predicted vector by multiplying a matrix for prediction over the entire first split vector.

### Embodiment 2

An example case will be explained with Embodiment 2 where split vector quantization is performed utilizing the correlation between a first split vector and a second split vector by switching codebooks to which second split vector quantization refers.

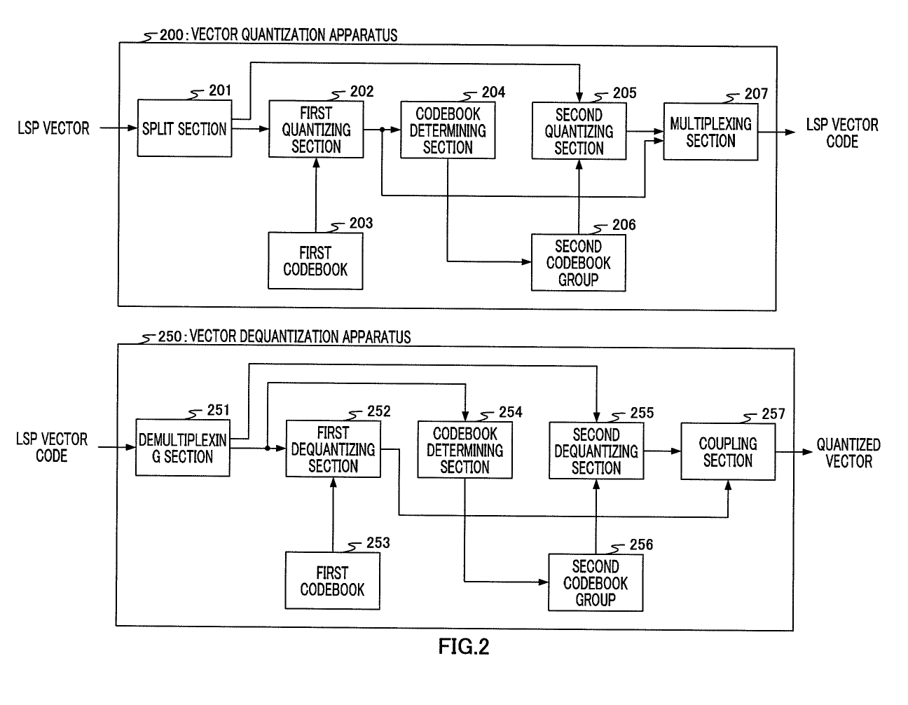

FIG. 2 is a block diagram showing main components of the vector quantization apparatus and vector dequantization apparatus according to Embodiment 2 of the present invention.

In FIG. 2, vector quantization apparatus 200 is mainly configured with split section 201, first quantizing section 202, first codebook 203, codebook determining section 204, second quantizing section 205, second codebook group 206 and multiplexing section 207. Further, vector dequantization apparatus 250 is mainly configured with demultiplexing section 251, first dequantizing section 252, first codebook 253, codebook determining section 254, second dequantizing section 255, second codebook group 256 and coupling section 257. Here, second codebook groups 206 and 256 have a plurality of codebooks prepared in advance. Codebooks determining sections 204 and 205 determine the codebooks for use in second dequantizing sections 205 and 255 according to the first code, respectively.

The operations of a vector quantization apparatus and vector dequantization apparatus employing the above configurations will be explained below.

First, the operations of the sections of vector quantization apparatus 200 will be explained.

Split section 201 receives as input an input vector which is an LSP vector. Split section 201 splits the inputted LSP vector into two and outputs the first split vector to first quantizing section 202 and the second split vector to second quantizing section 205.

First quantizing section 202 receives as input the first split vector, quantizes the first split vector and outputs the first code representing the first quantized split vector acquired by quantization, to codebook determining section 204 and multiplexing section 207.

Codebook determining section 204 receives as input the first code, selects the codebook to which second quantizing section 205 refers, from second codebook group 206 according to the first code and outputs the index of the selected codebook to second codebook group 206.

Second codebook group 206 receives as input the index from codebook determining section 204, acquires the codebook associated with the index from a plurality of codebooks provided from second codebook group 206, and outputs the acquired codebook to second quantizing section 205 as the codebook to which second quantizing section 205 refers upon vector quantization.

As described above, by selecting the codebook to which second quantizing section 205 refers upon split vector quantization, from a plurality of codebooks according to the first code, it is possible to improve the performance of split vector quantization using the correlation between the first split vector and the second split vector.

Second quantizing section 205 receives as input the second split vector, quantizes the second split vector and outputs the second code acquired by the quantization to multiplexing section 207. Upon performing vector quantization, second quantizing section 205 refers to the codebook provided from second codebook group 206.

Multiplexing section 207 receives as input the first code and the second code, multiplexes these codes and outputs the result as an LSP vector code.

Next, the operations of the sections of vector dequantization apparatus 250 will be explained.

Demultiplexing section 251 receives as input the LSP vector code. Demultiplexing section 251 demultiplexes the LSP vector code into the first code and the second code, outputs the first code to first dequantizing section 252 and codebook determining section 254, and outputs the second code to second dequantizing section 255.

First dequantizing section 252 dequantizes the first code and outputs the first quantized split vector acquired by the dequantization to coupling section 257. First dequantizing section 252 refers to first codebook 253 when first dequantizing section 252 performs vector dequantization.

Codebook determining section 254 receives as input the first code, selects the codebook to which second dequantizing section 255 refers, from second codebook group 256 according to the first code, and outputs the index of the selected codebook to second codebook grope 256.

Second codebook group 256 receives as input the index from codebook determining section 254, acquires the codebook associated with the index from a plurality of codebooks provided from second codebook group 256, and outputs the acquired codebook to second dequantizing section 255 as the codebook to which second dequantizing section 255 refers upon dequantization.

Second dequantizing section 255 receives as input the second code, dequantizes the second code and outputs the second quantized split vector acquired by the dequantization, to coupling section 257. Second dequantizing section 255 refers to the codebook provided from second codebook group 256 when second dequantizing section 255 performs vector dequantization.

Coupling section 257 receives as input the first quantized split vector and the second quantized split vector, finds a quantized vector by coupling these vectors and outputs the quantized vector.

Next, the operations of the sections of vector quantization apparatus 200 and vector dequantization apparatus 250 will be explained in further detail.

First, the operations of the sections of vector quantization apparatus 200 will be explained.

An example case will be explained where an LSP vector to be quantized is a vector of the R order (LSP(i) (i=0 to R−1)) and where vector quantization apparatus 200 splits the vector of the R order into two, namely, a split vector of the R_P order and a split vector of the R_F order and performs split vector quantization. Further, the number of multiple codebooks provided from second codebook groups 206 and 256 is referred to as “S,” and the codebooks are assigned indexes in order from 0 to S−1.

Split section 201 splits an input LSP vector (LSP(i) (i=0 to R−1)) according to following equation 8. In the LSP vector (LSP (i) (i=0 to R−1)), the value of a frequency increases in order from the LSP(0), which is the lowest frequency to the LSP(R−1), which is the highest frequency.

[8]

LSP_{—}P(i)=LSP(i) (i=0, . . . , R_P−1)

LSP_{—}F(i)=LSP(i+R_{—}P) (i=0, . . . , R_F−1) (Equation 8)

In above equation 8, assume that the first split vector is the LSP_P(i) (i=0 to R_P−1) and the second split vector is the LSP_F(i) (i=0 to R_F−1). Further, the sum of R_P and R_F corresponds to R (R=R_P+R_F). Next, the first split vector and the second split vector are outputted to first quantizing section 202.

First quantizing section 202 receives as input the first split vector LSP_P(i) (i=0 to R_P), and, with reference to first codebook 203 prepared in advance by learning, and selects the code vector that minimizes the square error between the code vector and the first split vector LSP_P(i) (i=0 to R_P) using following equation 9.

$$\begin{matrix}( Equation 9 ) & \\ Err\_P = {\sum }_{i = 0}^{R\_P - 1} {( LSP\_P ( i ) - {CODE\_P}^{( m )} ( i ) )}^{2} & [ 9 ]\end{matrix}$$

Here, CODE_P^{(m)} (i) (i=0 to R_P−1) is the code vectors forming first codebook 203 and m is the indexes of the code vectors. When the codebook size of first codebook 103 is M, m take values between 0 and M−1. Next, first quantizing section 202 calculates values of the square error Err_P using all m's, and outputs the m that minimizes the value of the square error Err_P as the first code m_min to codebook determining section 204.

Next, codebook determining section 204 receives as input the first code m_min, determines the codebook to which second quantizing section 205 refers upon vector quantization, according to the value of the first code m_min, and outputs the index “s” (which is an arbitrary value between 0 and S−1) of the determined codebook to second codebook group 206.

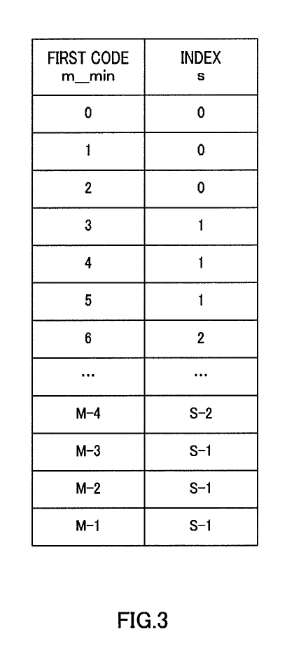

FIG. 3 illustrates an example of an association table between first codes and indexes of the second codebook.

As shown in FIG. 3, the relationships between the index s and the first code m_min is determined in advance, and, according to these relationships, the index s is determined from the first code m_min.

Next, second codebook group 206 receives as input the index s, selects the codebook associated with the index s from a plurality of codebooks provided from second codebook group 206 and outputs the selected codebook as the codebook to which second quantizing section 205 refers upon vector quantization, to second vector quantizing section 205.

Next, second quantizing section 205 receives as input the second split vector LSP_F(i) (i=0 to R_F−1), and, with reference to the codebook provided from second codebook group 206 in association with the index s, selects the code vector that minimizes the square error between the code vector and the second split vector LSP_F(i) using following equation 10.

$$\begin{matrix}( Equation 10 ) & \\ Err\_F = {\sum }_{i = 0}^{R\_F - 1} {( LSP\_F ( i ) - {CODE\_F}^{( n )} ( i ) )}^{2} & [ 10 ]\end{matrix}$$

However, CODE_F⁽ⁿ⁾(i) (i=0 to R_F−1) is the code vectors forming the codebook provided from second codebook group 206 and n is the indexes of the code vectors. If the codebook size of second codebook 106 is N, n take values between 0 and N−1. Next, second quantizing section 205 calculates the values of the square error Err_F in all n's and outputs the value of the n that minimizes the value of the square error Err_F as the second code n_min, to multiplexing section 207.

Next, multiplexing section 207 receives as input the first code m_min and the second code n_min, and multiplexes these codes into an LSP vector.

As described above, by switching the codebook to which second quantizing section 205 refers upon vector quantization, according to the first code representing the quantization result in first quantizing section 202, it is possible to improve the performance of split vector quantization utilizing the correlation between the first split vector and the second split vector.

Next, the operations of the sections of vector dequantization apparatus 250 will be explained in detail. An example case will be explained where an LSP vector to be quantized is a vector of the R order (LSP(i) (i=0 to R−1)) and where vector dequantization apparatus 250 acquires a quantized vector by dequantizing an LSP vector code. Further, first codebook 253 has the same configuration as first codebook 203 in vector quantization apparatus 200 and second codebook group 256 has the same configuration as second codebook group 206 in vector quantization apparatus 200.

First, demultiplexing section 151 demultiplexes the LSP vector into the first code m_min and the second code n_min and outputs the first code m_min to first dequantizing section 252 and the second code n_min to second dequantizing section 255.

Next, first dequantizing section 252 acquires the first quantized split vector using the first code m_min. To be more specific, with reference to first codebook 253, the first quantized split vector CODE_P^{(m}^{_{—}}^{min)}(i) (i=0 to R_P−1) is acquired and outputted to coupling section 257.

Next, codebook determining section 254 receives as input the first code m_min, determines the index s of the codebook to which second dequantizing section 255 refers upon dequantization, according to the value of the first code m_min, and outputs the index s to second codebook group 256. To be more specific, as shown in FIG. 3, the relationships between the first code m_min and the index s are determined in advance and the index s is determined from the first code m_min according to these relations.

Next, second codebook group 256 receives as input the index s, selects the codebook associated with the index s from a plurality of codebooks provided from second codebook group 256, and outputs the codebook as the codebook to which second dequantizing section 255 refers upon vector dequantization, to second dequantizing section 255.

Next, second dequantizing section 255 receives as input the second code m_min and acquires the second quantized split vector using the second code n_min. To be more specific, with reference to the codebook provided from second codebook group 256 in association with the index s, second dequantizing section 255 acquires the second quantized split vector CODE_F⁽ⁿ^{_{—}}^{min)}(i) (i=0 to R_F−1) and outputs it to coupling section 257.

Next, coupling section 257 receives as input the first quantized split vector CODE_P^{(m}^{_{—}}^{min)}(i) (i=0 to R_P−1) and the second quantized split vector CODE_F⁽ⁿ^{_{—}}^{min)}(i) (i=0 to R_F−1), generates the quantized vector Q(i) (i=0 to R−1) by coupling the input vectors using following equation 11 and outputs the generated quantized vector Q(i) (i=0 to R_P−1).

[11]

Q(i)=CODE_{—}P^{(m}^{_{—}}^{min)}(i) (i=0, . . . , R_P−1)

Q(i+R_{—}P)=CODE_{—}F⁽ⁿ^{_{—}}^{min)}(i) (i=0, . . . , R_F−1) (Equation 11)

As described above, according to the present embodiment, it is possible to acquire the same effect as in Embodiment 1, that is, by changing the other code vector to be used for split vector quantization according to one or more results of split vector quantization, it is possible to improve the quality of split vector quantization utilizing the correlation between the higher order and the lower order of an input vector.

Further, according to the present embodiment, second codebook groups 206 and 256 prepare in advance a plurality of codebooks created by learning data, and codebook determining sections 204 and 254 selects and uses the optimal codebook by the learning effect, so that it is possible to improve the quality of quantization/dequantization.

Here, to acquire first codebooks 103 and 153 in advance by learning, it is preferable to prepare a large number of LSP vectors acquired from a large volume of speech data for learning, generate a large number of first split vectors LSP_P(i) (i=0 to R_P−1) based on above equation 1 using the LSP vectors, and generate a first codebook by learning algorithms such as the LBG algorithm using the first split vectors. Further, to acquire a plurality of codebooks provided from second codebook groups 206 and 256 in advance by learning, as shown in FIG. 3, the relationships between the first code m_min and the index s need to be determined in advance after the first codebook is generated as above. To determine the relationships, when the number of multiple codebooks provided from the second codebook groups is S, it is preferable to cluster the M code vectors forming the first codebook into S clusters having indexes 0 to S−1 and associate the clustered indexes and the indexes of the code vectors that belong to the clusters. Next, it is preferable to generate a large number of first split vectors LSP_P(i) (i=0 to R_P−1) and second split vectors LSP_F(i) (i=0 to R_F−1) based on above equation 1 using a large number of LSP vectors, select the code vector that minimizes the square error between the code vector and the first split vector LSP_P(i) (i=0 to R_P−1) based on above equation 2 with reference to the first codebooks every pair of the first split vector and the second split vector, determine the index of the codebook from the index (first code m_min) of the selected code vector with reference to the above relationships, and associate the second split vector with learning data of the codebook of the index s. After these processing, it is preferable to generate codebooks forming the second codebook group using the second split vectors associated with the codebooks based on learning algorithms such as the LBG algorithm.

Here, above explanations are examples of best modes for carrying out the present invention, and the scope of the present invention is not limited to these.

For example, although example cases have been described with the above embodiments where an LSP vector is split into two and quantized, the number of splits is not limited to two and may be three or more.

Further, example cases have been described with the above embodiments where an LSP vector is quantized, the quantization target is not limited to this and may be different vectors from an LSP vector. In this case, it is effective to use such a vector that, when the vector is split, the split vectors have the correlation with each other, as a vector to be quantized.

Further, although the names of “vector quantization apparatus” and “dequantization apparatus” are used with the present embodiment, these are used for ease of explanations and therefore may be a “quantization apparatus,” “dequantization apparatus,” “vector quantization method,” “vector dequantization method” and so on.

Although an example case has been described with the above embodiments where the present invention is implemented with hardware, the present invention can be implemented with software for enabling quantization and dequantization. This software is stored in computer-readable record media.

Further, the vector quantization apparatus and dequantization apparatus according to the present invention can be included in a communication terminal apparatus and base station apparatus in mobile communication systems, so that it is possible to provide a communication terminal apparatus, base station apparatus and mobile communication systems having the same operational effect as above.

Although a case has been described with the above embodiments as an example where the present invention is implemented with hardware, the present invention can be implemented with software. For example, by describing the algorithm according to the present invention in a programming language, storing this program in a memory and making the information processing section execute this program, it is possible to implement the same function as the speech coding apparatus of the present invention.

Furthermore, each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2006-099854, filed on Mar. 31, 2006, including the specification, drawings and abstract, is incorporated herein by reference in its entirety.

### INDUSTRIAL APPLICABILITY

The vector quantization apparatus, vector dequantization apparatus and these methods of the present invention can implement LSP coding with high quality by performing split vector quantization with the good performance utilizing the correlation between the lower order and the higher order of a vector, and therefore are useful as an LSP coder in a speech/sound coding apparatus and speech/sound decoding apparatus that are used in the communication system for coding and transmitting speech/sound.

1. A vector quantization apparatus comprising:
a split section that splits an input vector and acquires a plurality of split vectors;
a first quantizing section that quantizes one of the split vectors and acquires a first quantized split vector and a first code representing the first quantized split vector;
a second quantizing section that quantizes another split vector using a quantization result in the first quantizing section and acquires a second code; and
a multiplexing section that multiplexes the first code and the second code and acquires a vector code.

2. The vector quantization apparatus according to claim 1, further comprising a prediction residual generating section that generates a predicted vector by performing a prediction using the first quantized split vector and generates a prediction residual vector representing a prediction error between the predicted vector and the another split vector,
wherein the second quantizing section quantizes the prediction residual vector and acquires the second code.

3. The vector quantization apparatus according to claim 2, wherein the prediction residual generating section performs a prediction using a higher order of the first quantized split vector.

4. The vector quantization apparatus according to claim 2, wherein the prediction residual generating section performs a prediction by multiplying the first quantized split vector and a prediction matrix.

5. The vector quantization apparatus according to claim 1, further comprising a codebook determining section that determines a codebook used in the second quantizing section according to the first code,
wherein the second quantizing section acquires the second code by quantizing the another split vector using the codebook determined in the codebook determining section.

6. The vector quantization apparatus according to claim 1, wherein the input vector comprises a vector having a correlation between a higher order and a lower order including a line spectral pair parameter.

7. A dequantization apparatus comprising:
a demultiplexing section that demultiplexes a vector code multiplexing a first code and a second code into the first code and the second code, the first code representing a first quantized split vector acquired by quantizing one of the split vectors of an input vector, the second code being acquired by quantizing another split vector using the first quantized split vector;
a first dequantizing section that dequantizes the first code and acquires a first quantized split vector;
a second dequantizing section that acquires a second quantized split vector by dequantizing the second code using a dequantization result in the first dequantizing section; and
a coupling section that couples the first quantized split vector and the second quantized split vector and generates a quantized vector.

8. A dequantization apparatus comprising:
a demultiplexing section that demultiplexes a vector code multiplexing a first code and a second code into the first code and the second code, the first code representing a first quantized split vector acquired by quantizing one of split vectors of an input vector, the second code being acquired by quantizing another split vector using a codebook determined according to the first quantized split vector;
a first dequantizing section that acquires a first quantized split vector by dequantizing the first code;
a second dequantizing section that dequantizes the second code and acquires a quantization prediction residual vector;
a prediction residual combining section that generates a predicted vector by performing a prediction using the first quantized split vector and generates a second quantized split vector by adding the predicted vector and the quantization prediction residual vector; and
a coupling section that couples the first quantized split vector and the second quantized split vector and generates a quantized vector.

9. A dequantization apparatus comprising:
a demultiplexing section that demultiplexes a vector code multiplexing a first code and a second code into the first code and the second code, the first code representing a first quantized split vector acquired by quantizing one of split vectors of an input vector, the second code being acquired by quantizing a prediction residual vector representing a prediction error between a predicted vector predicted using the first quantized split vector and another split vector;
a first dequantizing section that dequantizes the first code and acquires a first quantized split vector;
a codebook determining section that determines a codebook according to the first code;
a second dequantizing section that acquires a second quantized split vector by dequantizing the second code using the codebook determined in the codebook determining section; and
a coupling section that couples the first quantized split vector and the second quantized split vector and generates a quantized vector.

10. A vector quantization method comprising:
a split step of splitting an input vector into a plurality and acquiring a plurality of split vectors;
a first quantization step of quantizing one of the split vectors and a first code representing the first quantized split vector and acquiring a first quantized split vector;
a second quantization step of quantizing another split vector using a quantization result in the first quantizing step and acquiring a second code; and
a multiplexing step of multiplexing the first code and the second code and acquiring a vector code.

11. The vector quantization method according to claim 10, further comprising a prediction residual generating step of generating a predicted vector by performing a prediction using the first quantized split vector and generating a prediction residual vector representing a prediction error between the predicted vector and another split vector,
wherein the second quantization step quantizes the prediction residual vector and acquires the second code.

12. The vector quantization method according to claim 10, further comprising a codebook determining step of determining a codebook used in the second quantization step according to the first code,
wherein the second quantization step acquires the second code by quantizing the another split vector using the codebook determined in the codebook determining step.

13. A vector dequantization method comprising:
a demultiplexing step of demultiplexing a vector code multiplexing a first code and a second code into the first code and the second code, the first code representing a first quantized split vector being acquired by quantizing one of split vectors of an input vector, the second code being acquired by quantizing another split vector using the first quantized split vector;
a first dequantization step of dequantizing the first code and acquiring a first quantized split vector;
a second dequantization step of acquiring a second quantized split vector by dequantizing the second code using a dequantization result in the first dequantizing step; and
a coupling step of coupling the first quantized split vector and the second quantized split vector and generating a quantized vector.

14. A vector dequantization method comprising:
a demultiplexing step of demultiplexing a vector code multiplexing a first code and a second code into the first code and the second code, the first code representing a first quantized split vector being acquired by quantizing one of split vectors of an input vector, the second code being acquired by quantizing another split vector using a codebook determined according to the first quantized split vector;
a first dequantization step of dequantizing the first code and acquiring a first quantized split vector;
a second dequantization step of dequantizing the second code and acquiring a quantization prediction residual vector;
a prediction residual combining step of generating a predicted vector by performing a prediction using the first quantized split vector and generating a second quantized split vector by adding the predicted vector and the quantization prediction residual vector; and
a coupling step of coupling the first quantized split vector and the second quantized split vector and generating a quantized vector.

15. A dequantization method comprising:
a demultiplexing step of demultiplexing a vector code multiplexing a first code and a second code into the first code and the second code, the first code representing a first quantized split vector being acquired by quantizing one of split vectors of an input vector, the second code being acquired by quantizing a prediction residual vector representing a prediction error between a predicted vector predicted using the first quantized split vector and another split vector;
a first dequantization step of dequantizing the first code and acquiring a first quantized split vector;
a codebook determining step of determining a codebook according to the first code;
a second dequantization step of acquiring a second quantized split vector by dequantizing the second code using the codebook determined in the codebook determining step; and
a coupling step of coupling the first quantized split vector and the second quantized split vector and generating a quantized vector.
